(19) United States
(12) Patent Application Publication
(10) Pub. No.: US 2023/0211321 A1
(43) Pub. Date: Jul. 6, 2023

(54) AMMONIA SYNTHESIS CATALYST AND METHOD FOR MANUFACTURING AMMONIA

(71) Applicants: SAKAI CHEMICAL INDUSTRY CO., LTD., Sakai-shi, Osaka (JP); NAATIONAL INSTITUTE OF ADVANCED INDUSTRIAL SCIENC AND TECHNOLOGY, Tokyo (JP)

(72) Inventors: Hiroshi TSUTSUMI, Osaka (JP); Daisuke YAMASHITA, Osaka (JP); Akihiro KAMON, Osaka (JP); Akiyo OZAWA, Osaka (JP); Tetsuya NAMBA, Fukushima (JP); Rahat JAVAID, Fukushima (JP); Yuichi MANAKA, Fukushima (JP)

(21) Appl. No.: 17/998,887

(22) PCT Filed: May 7, 2021
(86) PCT No.: PCT/JP2021/017505

§ 371 Date: Nov. 15, 2022

(30) Foreign Application Priority Data
May 19, 2020 (JP) 2020-087452

(51) Int. Cl. B01J 23/46; B01J 21/06; B01J 35/00; C01C 1/04

(52) U.S. Cl. CPC B01J 23/462; B01J 21/063; B01J 35/0066; C01C 1/0411

(57) ABSTRACT

Provided is a catalyst that is free from catalyst deactivation caused by reaction of the support and exhibits good catalytic activity in an ammonia synthesis reaction in a low-temperature, low-pressure process. The present invention relates to an ammonia synthesis catalyst having a structure in which at least one of ruthenium or an oxide of ruthenium is loaded on a titanium suboxide support represented by the composition formula TiOx where x represents a number satisfying 1.5<x<2.0.

### TECHNICAL FIELD

The present invention relates to ammonia synthesis catalysts and methods for producing ammonia.

### BACKGROUND ART

Ammonia has long been produced as a raw material of chemical fertilizers and other products. Owing to its high hydrogen density per volume, ammonia has recently attracted attention as a promising hydrogen carrier for the realization of a future hydrogen society.

Ammonia has been industrially produced using the Haber-Bosch process for about 100 years, which synthesizes ammonia mainly through reaction of nitrogen in air with hydrogen. The Haber-Bosch process synthesizes ammonia in a high-temperature, high-pressure environment using a catalyst mainly containing iron oxide. Recently, a novel process has attracted attention which enables reaction under low-temperature, low-pressure conditions by using an active metal catalyst such as ruthenium. Such a low-temperature, low-pressure process as described above, which can be easily started and stopped, is suitable to cope with unstable hydrogen supply in the synthesis of ammonia using hydrogen which is renewable energy produced using wind or solar power generation. In response to this, highly active catalysts that enable reactions at lower temperatures and lower pressures have been developed.

As such an ammonia synthesis catalyst, a ruthenium-loaded carbon catalyst has been proposed, for example (see, for example, Patent Literature 1).

### CITATION LIST

### Patent Literature

Patent Literature 1: JP S60-500754 A

### SUMMARY OF INVENTION

### Technical Problem

Ruthenium-loaded carbon is highly active, while the carbon reacts with hydrogen to cause methanation, causing catalyst deactivation. To solve such a problem of catalyst deactivation caused by reaction of a support, catalysts that can be used in low-temperature, low-pressure processes have been required.

In view of the current situation described above, the present invention aims to provide a catalyst that is free from catalyst deactivation caused by reaction of the support and exhibits good catalytic activity in an ammonia synthesis reaction in a low-temperature, low-pressure process.

### Solution to Problem

The present inventors have made various studies on a catalyst that is free from catalyst deactivation caused by reaction of the support and exhibits good catalytic activity in an ammonia synthesis reaction in a low-temperature, low-pressure process. They found that a catalyst in which ruthenium and/or an oxide of ruthenium is loaded on a titanium suboxide support represented by the composition formula TiOx where x represents a number satisfying 1.5<x<2.0 is free from catalyst deactivation caused by reaction of the support, which can occur on ruthenium-loaded carbon, and exhibits good catalytic activity in an ammonia synthesis reaction in a low-temperature, low-pressure process. Thereby, the present invention has been completed.

That is, the present invention relates to an ammonia synthesis catalyst having a structure in which at least one of ruthenium or an oxide of ruthenium is loaded on a titanium suboxide support represented by the composition formula TiOx where x represents a number satisfying 1.5<x<2.0.

Preferably, a loading amount of the at least one of ruthenium or an oxide of ruthenium is 0.1 to 30 parts by weight in terms of ruthenium metal element based on total 100 parts by weight of the ammonia synthesis catalyst.

Preferably, the ammonia synthesis catalyst has a structure in which at least one of a simple substance of a metal element having a lower Pauling electronegativity than titanium or a compound of the metal element is loaded on the support.

Preferably, a loading amount of the at least one of a simple substance of a metal element having a lower Pauling electronegativity than titanium or a compound of the metal element is 0.1 to 50 parts by weight in terms of metal element based on total 100 parts by weight of the ammonia synthesis catalyst.

The present invention also relates to a method for producing ammonia, including:

using the ammonia synthesis catalyst of the present invention.

### Advantageous Effects of Invention

The ammonia synthesis catalyst of the present invention is free from catalyst deactivation caused by reaction of the support and exhibits good catalytic activity in a low-temperature, low-pressure process, and thus can be suitably used for the industrial production of ammonia.

### DESCRIPTION OF EMBODIMENTS

Preferred embodiments of the present invention are specifically described below, but the present invention is not limited to the following description, and modification may be suitably made without departing from the gist of the present invention.

### 1. Ammonia Synthesis Catalyst

The ammonia synthesis catalyst of the present invention has a structure in which ruthenium and/or an oxide of ruthenium is loaded on a titanium suboxide support represented by the composition formula TiOx where x represents a number satisfying 1.5<x<2.0.

The titanium suboxide support is required to be represented by the composition formula TiOx where x represents a number satisfying 1.5<x<2.0, preferably a number satisfying 1.7≤x≤1.98.

The titanium suboxide preferably has a specific surface area of 10 m²/g or more. The titanium suboxide having such a specific surface area can load a larger amount of ruthenium and/or an oxide of ruthenium and can provide a catalyst having higher catalytic activity. The specific surface area of the titanium suboxide is more preferably 20 m²/g or more, still more preferably 30 m²/g or more.

The specific surface area of the titanium suboxide can be measured by the method described in the EXAMPLES below.

The titanium suboxide preferably has a brightness value L* of 20 or higher, more preferably 30 or higher, in the L*a*b* color system. In addition, the titanium suboxide preferably has a chromaticity value b* of not higher than 0, more preferably not higher than −2, still more preferably not higher than −3, particularly preferably not higher than −4, in the L*a*b* color system. Use of titanium suboxide having such a brightness value L* and such a chromaticity value b* can provide a highly active catalyst because ruthenium and/or an oxide of ruthenium loaded on the support can efficiently react with hydrogen and nitrogen.

The brightness value L* and chromaticity value b* can be determined by the method described in the EXAMPLES below.

The ammonia synthesis catalyst of the present invention may be a catalyst in which a simple substance of ruthenium is loaded on a titanium suboxide or a catalyst in which ruthenium oxide is loaded on a titanium suboxide.

The loading amount of ruthenium and/or an oxide of ruthenium in the ammonia synthesis catalyst is preferably 0.1 to 30 parts by weight in terms of ruthenium metal element based on total 100 parts by weight of the ammonia synthesis catalyst. The ammonia synthesis catalyst having such a loading amount can have higher catalytic activity. The loading amount of ruthenium and/or an oxide of ruthenium is more preferably 0.5 to 20 parts by weight, still more preferably 1 to 10 parts by weight.

The ammonia synthesis catalyst of the present invention preferably has a structure in which not only ruthenium and/or an oxide of ruthenium but also a simple substance of a metal element having a Pauling electronegativity lower than the Pauling electronegativity of titanium of 1.54 and/or a compound of the metal element are loaded on a support. When the metal element loaded on a titanium suboxide support has a lower electronegativity than titanium, the metal element can efficiently donate electrons to the titanium suboxide support and ruthenium and/or an oxide of ruthenium. A simple substance of a metal element having a lower electronegativity than titanium and/or an oxide of the metal element is a component acting as an auxiliary catalyst. Loading of such a component allows the catalyst of the present invention to have higher catalytic activity for the ammonia synthesis reaction.

The values of the Pauling electronegativity are from “Nobuo Suzuki, Chemistry Handbook (Kagaku Binran), Revised 4th Edition, Basic Part II, p. 631”.

Herein, the term “electronegativity” refers to the Pauling electronegativity.

Examples of the metal element having a lower electronegativity than titanium include the metal elements of Group I of the periodic table, such as lithium, sodium, potassium, rubidium, and cesium; the metal elements of Group II of the periodic table, such as magnesium, calcium, strontium, and barium; the metal elements of Group III of the periodic table, such as scandium and yttrium; the metal elements of Group IV of the periodic table, such as zirconia and hafnium; the metal elements of Group V of the periodic table, such as tantalum; and lanthanides such as lanthanum, cerium, praseodymium, neodymium, promethium, samarium, europium, gadolinium, dysprosium, holmium, erbium, thulium, ytterbium, and lutetium. One or more of these may be used.

Preferred among these are calcium, cesium, strontium, barium, magnesium, lanthanum, and cerium. More preferred are calcium, cesium, and lanthanum.

Non-limiting examples of the compound of any of the metal elements having a lower electronegativity than titanium include oxides, hydroxides, nitrides, chlorides, bromides, iodides, nitrates, hydrochlorides, carbonates, sulfates, and phosphates.

The simple substance of a metal element having a lower electronegativity than titanium and/or a compound of the metal element loaded on a support in the ammonia synthesis catalyst of the present invention preferably includes one or more of simple substances of metals, oxides, hydroxides, nitrides, nitrates, and carbonates.

The loading amount of the simple substance of a metal element having a lower electronegativity than titanium and/or an oxide of the metal element is preferably 0.1 to 50 parts by weight in terms of metal element based on total 100 parts by weight of the ammonia synthesis catalyst. The ammonia synthesis catalyst having such a loading amount sufficiently exhibits the effect of loading the simple substance of a metal element having a lower electronegativity than titanium and/or an oxide of the metal element and can have higher catalytic activity for an ammonia synthesis reaction. The loading amount of the simple substance of a metal element having a lower electronegativity than titanium and/or an oxide of the metal element is more preferably 0.2 to 40 parts by weight, still more preferably 0.5 to 30 parts by weight in terms of metal element.

When two or more selected from the group consisting of the simple substances of metal elements having a lower electronegativity than titanium and/or oxides of the metal elements are loaded on a support, the combined loading amount thereof preferably falls within the range indicated above.

### 2. Method for Producing Ammonia Synthesis Catalyst

The ammonia synthesis catalyst of the present invention has a structure in which ruthenium and/or an oxide of ruthenium is loaded on a titanium suboxide support. Ruthenium and/or an oxide of ruthenium may be loaded on a support by any technique such as impregnation, liquid phase reduction, or physical mixing. Preferred among these is impregnation. The following describes an example of a method for producing a titanium suboxide support on which ruthenium and/or an oxide of ruthenium is loaded by impregnation.

The ammonia synthesis catalyst of the present invention can be produced by a production method including a step of loading ruthenium and/or an oxide of ruthenium on a titanium suboxide support, the step including: mixing titanium suboxide and a simple substance of ruthenium and/or a compound of ruthenium (hereinafter also referred to as a ruthenium species) to provide a ruthenium species mixture; and sintering the ruthenium species mixture obtained in the mixing.

In order to allow the ammonia synthesis catalyst of the present invention to have a structure in which not only ruthenium and/or an oxide of ruthenium but also a simple substance of a metal element having a lower electronegativity than titanate and/or a compound of the metal element are loaded on the titanium suboxide support, the production method includes a step of loading a simple substance of a metal element having a lower electronegativity than titanate and/or a compound of the metal element on the titanium suboxide support, as well as the above-described step. The step of loading a simple substance of a metal element having a lower electronegativity than titanium and/or a compound of the metal element on the titanium suboxide support may be performed simultaneously with the above-described step. The loading a simple substance of a metal element having a lower electronegativity than titanium and/or a compound of the metal element on the titanium suboxide support may be performed by any technique such as impregnation, liquid phase reduction, or physical mixing. Preferred among these is impregnation. The following describes an example of the method of loading a simple substance of a metal element having a lower electronegativity than titanium and/or a compound of the metal element on the titanium suboxide support using impregnation.

The step of loading a simple substance of a metal element having a lower electronegativity than titanium and/or a compound of the metal element on the titanium suboxide support includes: mixing titanium suboxide and a simple substance of a metal element having a lower electronegativity than titanium and/or a compound of the metal element (hereinafter, also referred to as a low electronegativity metal species) to provide a low electronegativity metal species mixture; and sintering the low electronegativity metal species mixture obtained in the mixing.

The step of loading ruthenium and/or an oxide of ruthenium on a titanium suboxide support and the step of loading a simple substance of a metal element having a lower electronegativity than titanium and/or a compound of the metal element on the titanium suboxide support may be performed either first or simultaneously.

When the step of loading ruthenium and/or an oxide of ruthenium on a titanium suboxide support is performed first, the step of obtaining low electronegativity metal species mixture is the step of mixing: titanium suboxide loaded with ruthenium and/or an oxide of ruthenium; and a simple substance of a metal element having a lower electronegativity than titanium and/or a compound of the metal element.

When the step of loading a simple substance of a metal element having a lower electronegativity than titanium and/or a compound of the metal element is performed first, the step of obtaining ruthenium species mixture is the step of mixing: titanium suboxide loaded with a simple substance of a metal element having a lower electronegativity than titanium and/or a compound of the metal element; and a simple substance of ruthenium and/or a compound of ruthenium.

The following describes the step of loading ruthenium and/or an oxide of ruthenium on a titanium suboxide support, and the step of loading a simple substance of a metal element having a lower electronegativity than titanium and/or a compound of the metal element on the titanium suboxide support, followed by description of a method for preparing titanium suboxide.

(1) Step of Loading Ruthenium and/or Oxide of Ruthenium on Titanium Suboxide Support

The ruthenium compound for use in the step of loading ruthenium and/or an oxide of ruthenium on a titanium suboxide support may be any compound containing ruthenium.

Examples thereof include ruthenium nitrate, ruthenium chloride, ruthenium oxide, ruthenium acetylacetonate, potassium ruthenium cyanate, sodium ruthenate, potassium ruthenate, triruthenium dodecacarbonyl, ruthenium nitrosyl nitrate, tris(dipivaloylmethanato)ruthenium, hexaammine ruthenium chloride, and hydroxonitrosyltetraammine ruthenium nitrate. One or more of these may be used. Preferred among these are ruthenium nitrate and ruthenium chloride.

The mixing a ruthenium species with titanium suboxide or titanium suboxide loaded with a simple substance of a metal element having a lower electronegativity than titanium and/or a compound of the metal element may be performed by dry mixing or wet mixing and is preferably performed using a solvent. Use of a solvent in the mixing allows ruthenium and/or an oxide of ruthenium to be more fully loaded on the titanium suboxide.

Examples of the solvent usable include water, alcohols, ketones, and ether compounds. Preferred is water.

When a solvent is used to mix the ruthenium species with the titanium suboxide or titanium suboxide loaded with a simple substance of a metal element having a lower electronegativity than titanium and/or a compound of the metal element, preferably, the ruthenium species is dissolved in the solvent to prepare a solution of ruthenium species, which is mixed with the titanium suboxide or titanium suboxide loaded with a simple substance of a metal element having a lower electronegativity than titanium and/or a compound of the metal element. This allows the ruthenium species to be present on the surface of the titanium suboxide support more finely to increase the effective surface area of the ruthenium species.

When the solution of ruthenium species is mixed with the titanium suboxide or titanium suboxide loaded with a simple substance of a metal element having a lower electronegativity than titanium and/or a compound of the metal element, the titanium suboxide or titanium suboxide loaded with a simple substance of a metal element having a lower electronegativity than titanium and/or a compound of the metal element may be added to the solution of ruthenium species, and the solution may be stirred or allowed to stand.

In the mixing a ruthenium species with titanium suboxide or titanium suboxide loaded with a simple substance of a metal element having a lower electronegativity than titanium and/or a compound of the metal element, the amount of the ruthenium species is preferably such that the loading amount of ruthenium and/or an oxide of ruthenium is 0.1 to 30 parts by weight based on total 100 parts by weight of the ammonia synthesis catalyst. Such a ratio the ruthenium species can be present on the surface of the titanium suboxide support more finely to increase the effective surface area of the ruthenium species. The amount of the ruthenium species is more preferably such that the loading amount of ruthenium and/or an oxide of ruthenium is 0.5 to 20 parts by weight, still more preferably such that the loading amount of ruthenium and/or an oxide of ruthenium is 1 to 10 parts by weight.

When a solvent is used in the mixing a ruthenium species with titanium suboxide or titanium suboxide loaded with a simple substance of a metal element having a lower Pauling electronegativity than titanium or a compound of the metal element, the solvent is preferably removed before the sintering. This allows the sintering to be more efficient.

The solvent may be removed by any technique. Preferably, the solvent is evaporated or removed by heating the mixture. The heating temperature is preferably 60° C. to 150° C., more preferably 80° C. to 120° C.

The heating time is preferably 5 to 30 hours, more preferably 10 to 20 hours.

In the sintering the mixture of a ruthenium species and titanium suboxide or titanium suboxide loaded with a simple substance of a metal element having a lower Pauling electronegativity than titanium or a compound of the metal element, the sintering temperature is preferably 100° C. to 1000° C., more preferably 200° C. to 500° C.

The sintering time is preferably 10 to 300 minutes, more preferably 30 to 120 minutes.

The sintering is preferably performed in a reducing, inert, or vacuum atmosphere. The reducing atmosphere may be an atmosphere containing more than 0 vol % and not more than 100 vol % of a reducing gas such as hydrogen in an inert gas such as helium, nitrogen, or argon.

(2) Step of Loading Simple Substance of Metal Element Having Lower Electronegativity than Titanium and/or Compound of Metal Element on Titanium Suboxide Support

In the step of loading a simple substance of a metal element having a lower electronegativity than titanium and/or a compound of the metal element on a titanium suboxide support, the compound of a metal element having a lower electronegativity than titanium may be any compound. Examples thereof include oxides, hydroxides, nitrides, chlorides, bromides, iodides, nitrates, hydrochlorides, carbonates, sulfates, and phosphates. One or more of these may be used.

The metal element having a lower electronegativity than titanium is as described above.

The mixing a low electronegativity metal species with titanium suboxide or titanium suboxide loaded with ruthenium and/or an oxide of ruthenium may be performed by dry mixing or wet mixing and is preferably performed using a solvent. Use of a solvent in the mixing allows the simple substance of a metal element having a lower electronegativity than titanium and/or a compound of the metal element to be more fully loaded on the titanium suboxide.

Examples of the solvent usable include water, alcohols, ketones, and ether compounds. Preferred is water.

When a solvent is used to mix the low electronegativity metal species with the titanium suboxide or titanium suboxide loaded with ruthenium and/or an oxide of ruthenium, preferably, the low electronegativity metal species is dissolved in the solvent to prepare a solution of low electronegativity metal species, which is mixed with the titanium suboxide or titanium suboxide loaded with ruthenium and/or an oxide of ruthenium. This allows the low electronegativity metal species to be present on the surface of the titanium suboxide support more finely to increase the effective surface area of the low electronegativity metal species.

When the solution of low electronegativity metal species is mixed with the titanium suboxide or titanium suboxide loaded with ruthenium and/or an oxide of ruthenium, the titanium suboxide or titanium suboxide loaded with ruthenium and/or an oxide of ruthenium may be added to the solution of low electronegativity metal species, and the solution may be stirred or allowed to stand.

In the mixing a low electronegativity metal species with titanium suboxide or titanium suboxide loaded with ruthenium and/or an oxide of ruthenium, the amount of the low electronegativity metal species is preferably such that the loading amount of a simple substance of a metal element having a lower Pauling electronegativity than titanium or a compound of the metal element is 0.1 to 50 parts by weight based on total 100 parts by weight of the ammonia synthesis catalyst. Such a ratio of the low electronegativity metal species can be present on the surface of the titanium suboxide support more finely to increase the effective surface area of the low electronegativity metal species. The amount of the low electronegativity metal species is more preferably such that the loading amount of a simple substance of a metal element having a lower Pauling electronegativity than titanium or a compound of the metal element is 0.2 to 40 parts by weight, still more preferably such that the loading amount of a simple substance of a metal element having a lower Pauling electronegativity than titanium or a compound of the metal element is 0.5 to 30 parts by weight.

When a solvent is used in the mixing a low electronegativity metal species with titanium suboxide or titanium suboxide loaded with ruthenium and/or an oxide of ruthenium, the solvent is preferably removed before the sintering. This allows the sintering to be more efficient.

The solvent may be removed by any technique. Preferably, the solvent is evaporated or removed by heating the low electronegativity metal species mixture. The heating temperature is preferably 60° C. to 150° C., more preferably 80° C. to 120° C.

The heating time is preferably 1 to 30 hours, more preferably 1 to 10 hours.

In the sintering the mixture of a low electronegativity metal species and titanium suboxide or titanium suboxide loaded with ruthenium and/or an oxide of ruthenium, the sintering temperature is preferably 100° C. to 1000° C., more preferably 200° C. to 500° C. The sintering time is preferably 10 to 300 minutes, more preferably 30 to 120 minutes.

The sintering is preferably performed in a reducing, inert, or vacuum atmosphere. The reducing atmosphere may be an atmosphere containing more than 0 vol % and not more than 100 vol % of a reducing gas such as hydrogen in an inert gas such as helium, nitrogen, or argon.

### (3) Method for Preparing Titanium Suboxide

The titanium suboxide in the ammonia synthesis catalyst of the present invention can be prepared by reducing titanium oxide.

Titanium oxide may be reduced by any technique. Titanium oxide may be sintered in a reducing, inert, or vacuum atmosphere or may be sintered with titanium hydride. These may be used in combination.

When the titanium oxide is reduced to titanium suboxide, a component that acts to increase the specific surface area of the support may be added.

Examples of the component that acts to increase the specific surface area of the support include simple substances of elements such as silicon, aluminum, zinc, zirconium, and lanthanum and/or oxides, nitrides, and carbides of any of these. One or more of these may be used. These components act as ruthenium-loading supports together with titanium suboxide.

Preferred among these components are a simple substance of silicon and/or oxides, nitrides, carbides of silicon.

The addition amount of the component that acts to increase the specific surface area of the support is such that the amount of an element such as silicon, aluminum, zinc, zirconium, or lanthanum in the component is preferably 0.1 to 50 parts by weight, more preferably 1 to 20 parts by weight per 100 parts by weight of titanium element in titanium oxide used as a raw material of the titanium suboxide.

When the titanium oxide is reduced by sintering in a reducing atmosphere, the sintering is preferably performed at 500° C. to 1300° C., more preferably at 600° C. to 1000° C.

The sintering time in a reducing atmosphere is preferably 1 and 100 hours, more preferably 2 to 50 hours.

The reducing atmosphere may be the same as the reducing atmosphere for the sintering the ruthenium species mixture or the low electronegativity metal species mixture.

### 3. Method for Producing Ammonia

The ammonia synthesis catalyst of the present invention can be suitably used as a catalyst for synthesis reaction of ammonia from hydrogen and nitrogen. The present invention encompasses a method for producing ammonia using the ammonia synthesis catalyst of the present invention.

The method for producing ammonia is not limited as long as it can produce ammonia and is preferably a method of feeding a raw material gas containing nitrogen gas and hydrogen gas to the ammonia synthesis catalyst.

The molar ratio of nitrogen gas to hydrogen gas in the raw material gas is preferably 10:1 to 1:10, more preferably 1:1 to 1:6.

When ammonia is produced by feeding a raw material gas containing nitrogen gas and hydrogen gas to the ammonia synthesis catalyst, the temperature of the reaction is preferably room temperature to 700° C., more preferably 100° C. to 600° C.

The pressure of the reaction is preferably 0.01 to 10 MPa, more preferably 0.1 to 5 MPa.

### EXAMPLES

Specific examples are provided below to describe the present invention in detail, but the present invention is not limited to these examples. The “%” means “% by weight” unless otherwise specified. The following describes the measurement methods of the physical properties.

### Example 1

### (1) Production of Titanium Suboxide Support 1

First, 15.8 g of rutile titanium oxide (trade name: “STR-100N” available from Sakai Chemical Industry Co., Ltd., specific surface area: 100 m²/g) and 1.4 g of titanium hydride (trade name: “titanium hydride powder TCH-450” available from Toho Technical Service Co., Ltd.) were dry mixed. Then, the mixture was put in an alumina boat. The workpiece was put in an atmospheric furnace, and the temperature thereof was increased to 710° C. over 68 minutes under a flow of 100 vol % hydrogen of 400 ml/min. The temperature was kept at 710° C. for eight hours, and then lowered to room temperature by natural cooling. Thus, a titanium suboxide support 1 was obtained.

### (2) Production of Powder of Example 1

First, 1.0 ml of a ruthenium nitrate solution (TANAKA Kikinzoku Kogyo K.K., 50.47 mg/ml in terms of Ru) placed in a petri dish was stirred, and then, 1 g of the titanium suboxide support 1 was added to the petri dish, which was allowed to stand for 30 minutes. Thereafter, the Petri dish was put in an oven at 100° C. for 18 hours. Thus, a dry powder 1 was obtained. The dry powder 1 was put in an alumina boat. The workpiece was put in an atmospheric furnace, and the temperature thereof was increased to 300° C. over 10 minutes under a flow of 10 vol % hydrogen/nitrogen of 200 ml/min. The temperature was kept at 300° C. for one hour, and then lowered to room temperature by natural cooling. Thus, a powder of Example 1 was obtained.

### Example 2

First, 5.6 ml of a ruthenium chloride solution (N.E. CHEMCAT CORPORATION, 8.992 mg/ml in terms of Ru) placed in a petri dish was stirred, and then, 1 g of the titanium suboxide support 1 was added to the petri dish, which was allowed to stand for 30 minutes. Thereafter, the Petri dish was put in an oven at 100° C. for 18 hours. Thus, a dry powder 2 was obtained. The dry powder 2 was put in an alumina boat. The workpiece was put in an atmospheric furnace, and the temperature thereof was increased to 300° C. over 10 minutes under a flow of 10 vol % hydrogen/nitrogen of 200 ml/min. The temperature was kept at 300° C. for one hour, and then lowered to room temperature by natural cooling. Thus, a powder of Example 2 was obtained.

### Example 3

### (1) Production of Titanium Suboxide Support 2

First, 15.8 g of rutile titanium oxide (trade name: “STR-100N” available from Sakai Chemical Industry Co., Ltd., specific surface area: 100 m²/g) was put in an alumina boat. The workpiece was put in an atmospheric furnace, and the temperature thereof was increased to 710° C. over 68 minutes under a flow of 100 vol % hydrogen of 400 ml/min. The temperature was kept at 710° C. for eight hours, and then lowered to room temperature by natural cooling. Thus, a titanium suboxide support 2 was obtained.

### (2) Production of Powder of Example 3

A powder of Example 3 was produced as in Example 1, except that the titanium suboxide support 2 was used instead of the titanium suboxide support 1 used in the production of the powder of Example 1, the ruthenium nitrate solution was used in one-fifth the amount thereof used in Example 1, and to the ruthenium nitrate solution in the Petri dish was added 1.0 ml of ion-exchange water.

### Example 4

A powder of Example 4 was produced as in Example 1, except that the titanium suboxide support 2 was used instead of the titanium suboxide support 1 used in the production of the powder of Example 2 and the ruthenium nitrate solution was used in one-fifth the amount thereof used in Example 2.

### Example 5

### (1) Production of Titanium Suboxide Support 3

First, 15.8 g of anatase titanium oxide (trade name: “SSP-25” available from Sakai Chemical Industry Co., Ltd., specific surface area: 270 m²/g), 2.8 g of silicon dioxide (trade name: “silica” available from Sigma-Aldrich), and 2.8 g of titanium hydride (trade name: “titanium hydride powder TCH-450” available from Toho Technical Service Co., Ltd.) were dry mixed. Then, the mixture was put in an alumina boat. The workpiece was put in an atmospheric furnace, and the temperature thereof was increased to 800° C. over 77 minutes under a flow of 100 vol % hydrogen of 400 ml/min. The temperature was kept at 800° C. for eight hours, and then lowered to room temperature by natural cooling. Thus, a titanium suboxide support 3 was obtained.

### (2) Production of Powder of Example 5

A powder of Example 5 was produced as in Example 3, except that the titanium suboxide support 3 was used instead of the titanium suboxide support 2 used in the production of the powder of Example 3.

### Example 6

A powder of Example 6 was produced as in Example 5, except that the ruthenium nitrate solution was used in 10 times the amount thereof used in the production of the powder of Example 5 and no ion-exchange water was added.

### Example 7

A powder of Example 7 was produced as in Example 4, except that the titanium suboxide support 3 was used instead of the titanium suboxide support 2 used in the production of the powder of Example 4.

### Example 8

### (1) Production of Titanium Suboxide Support 4

First, 15.8 g of anatase titanium oxide (trade name: “SSP-25” available from Sakai Chemical Industry Co., Ltd., specific surface area: 270 m²/g) and 2.8 g of silicon dioxide (trade name: “silica” available from Sigma-Aldrich) were dry mixed. Then, the mixture was put in an alumina boat. The workpiece was put in an atmospheric furnace, and the temperature thereof was increased to 800° C. over 77 minutes under a flow of 100 vol % hydrogen of 400 ml/min. The temperature was kept at 800° C. for eight hours, and then lowered to room temperature by natural cooling. Thus, a titanium suboxide support 4 was obtained.

### (2) Production of Powder of Example 8

A powder of Example 8 was produced as in Example 3, except that the titanium suboxide support 4 was used instead of the titanium suboxide support 2 used in the production of the powder of Example 3.

### Example 9

A powder of Example 9 was produced as in Example 4, except that the titanium suboxide support 4 was used instead of the titanium suboxide support 2 used in the production of the powder of Example 4.

### Example 10

A powder of Example 10 was produced as in Example 8, except that the amount of the ruthenium nitrate solution in the production of the powder of Example 8 was changed to 1.0 ml.

### Example 11

First, 3.00 g of the titanium suboxide support 4, 1.77 g of calcium nitrate tetrahydrate (FUJIFILM Wako Pure Chemical Corporation), and 0.37 g of cesium carbonate (FUJIFILM Wako Pure Chemical Corporation) were added to 9 mL of ion-exchange water, and the contents were stirred for 30 minutes. Thereafter, the contents were dried to give a dry powder 3. The dry powder 3 was put in an alumina boat. The workpiece was put in an atmospheric furnace, and the temperature thereof was increased to 300° C. under a gas mixture flow containing nitrogen and 10 vol % of hydrogen of 200 ml/min. The temperature was kept at 300° C. for one hour, and then lowered to room temperature by natural cooling. Thus, a dry powder 4 was obtained. Separately, 3.3 ml of a ruthenium nitrate solution (50.47 mg/ml in terms of Ru, TANAKA Kikinzoku Kogyo K.K.) and 8 ml of ion-exchange water placed in an evaporating dish were stirred, and then, 3.00 g of the dry powder 4 was added to the evaporating dish and stirred for 30 minutes. The contents were heated on a stirrer hot plate at 120° C. to give a dry powder 5. The dry powder 5 was put in an alumina boat. The workpiece was put in an atmospheric furnace, and the temperature thereof was increased to 300° C. under a gas mixture flow containing nitrogen and 10 vol % of hydrogen of 200 ml/min. The temperature was kept at 300° C. for one hour, and then lowered to room temperature by natural cooling. Thus, a powder of Example 11 was obtained.

### Example 12

A powder of Example 12 was produced as in Example 11, except that the amount of cesium carbonate in the production of the powder of Example 11 was changed to 0.037 g.

### Example 13

A powder of Example 13 was produced as in Example 11, except that the amount of cesium carbonate in the production of the powder of Example 11 was changed to 0.74 g.

### Example 14

A powder of Example 14 was produced as in Example 11, except that the amount of calcium nitrate and the amount of cesium carbonate in the production of the powder of Example 11 was changed to 0.177 g and 0 g, respectively.

### Example 15

A powder of Example 15 was produced as in Example 14, except that the amount of calcium nitrate in the production of the powder of Example 14 was changed to 0.54 g.

### Example 16

A powder of Example 16 was produced as in Example 14, except that the amount of calcium nitrate in the production of the powder of Example 14 was changed to 1.77 g.

### Example 17

A powder of Example 17 was produced as in Example 14, except that the amount of calcium nitrate in the production of the powder of Example 14 was changed to 4.43 g.

### Example 18

A powder of Example 18 was produced as in Example 11, except that the amount of calcium nitrate in the production of the powder of Example 11 was changed to 0 g.

### Example 19

First, 3.00 g of the titanium suboxide support 4 and 3.16 g of magnesium nitrate hexahydrate (FUJIFILM Wako Pure Chemical Corporation) were added to 8 mL of ion-exchange water, and the contents were stirred for 30 minutes. Thereafter, the contents were dried to give a dry powder 6. The dry powder 6 was put in an alumina boat. The workpiece was put in an atmospheric furnace, and the temperature thereof was increased to 300° C. under a gas mixture flow containing 10 vol % of hydrogen of 200 ml/min. The temperature was kept at 300° C. for one hour, and then lowered to room temperature by natural cooling. Thus, a dry powder 7 was obtained. Separately, 3.3 ml of a ruthenium nitrate solution (50.47 mg/ml in terms of Ru, TANAKA Kikinzoku Kogyo K.K.) and 8 ml of ion-exchange water placed in an evaporating dish were stirred, and then, 3 g of the dry powder 7 was added to the evaporating dish and stirred for 30 minutes. The contents were heated on a stirrer hot plate at 120° C. to give a dry powder 8. The dry powder 8 was put in an alumina boat. The workpiece was put in an atmospheric furnace, and the temperature thereof was increased to 300° C. under a gas mixture flow containing nitrogen and 10 vol % of hydrogen of 200 ml/min. The temperature was kept at 300° C. for one hour, and then lowered to room temperature by natural cooling. Thus, a powder of Example 19 was obtained.

### Example 20

A powder of Example 20 was produced as in Example 19, except that the magnesium nitrate hexahydrate in the production of the powder of Example 19 was changed to 0.94 g of lanthanum nitrate hexahydrate.

### Example 21

A powder of Example 21 was produced as in Example 19, except that the magnesium nitrate hexahydrate in the production of the powder of Example 19 was changed to 0.69 g of barium hydroxide octahydrate.

### Example 22

A powder of Example 22 was produced as in Example 11, except that the cesium carbonate in the production of the powder of Example 11 was changed to 0.94 g of lanthanum nitrate hexahydrate.

### Example 23

A powder of Example 23 was produced as in Example 11, except that the cesium carbonate in the production of the powder of Example 11 was changed to 0.69 g of barium hydroxide octahydrate.

### Example 24

A powder of Example 24 was produced as in Example 11, except that the calcium nitrate and the cesium carbonate in the production of the powder of Example 11 were changed to 0.73 g of strontium nitrate and 0.94 g of lanthanum nitrate hexahydrate, respectively.

### Example 25

A powder of Example 25 was produced as in Example 11, except that the cesium carbonate in the production of the powder of Example 11 was changed to 0.80 g of cerium chloride heptahydrate.

### Example 26

A powder of Example 26 was produced as in Example 11, except that the calcium nitrate in the production of the powder of Example 11 was changed to 0.69 g of barium hydroxide octahydrate.

### Comparative Example 1

A powder of Comparative Example 1 was produced as in Example 3, except that rutile titanium oxide (trade name: “STR-100N” available from Sakai Chemical Industry Co., Ltd., specific surface area: 100 m²/g) was used instead of the titanium suboxide support 2 used in the production of the powder of Example 3.

### Comparative Example 2

A powder of Comparative Example 2 was produced as in Example 4, except that rutile titanium oxide (trade name: “STR-100N” available from Sakai Chemical Industry Co., Ltd., specific surface area: 100 m²/g) was used instead of the titanium suboxide support 2 used in the production of the powder of Example 4.

### Comparative Example 3

### (1) Production of Titanium Suboxide Support 5

First, 15.8 g of rutile titanium oxide (trade name: “STR-100N” available from Sakai Chemical Industry Co., Ltd., specific surface area: 100 m²/g) and 4.2 g of titanium hydride (trade name: “titanium hydride powder TCH-450” available from Toho Technical Service Co., Ltd.) were dry mixed. Then, the mixture was put in an alumina boat. The workpiece was put in an atmospheric furnace, and the temperature thereof was increased to 710° C. over 68 minutes under a flow of 100 vol % hydrogen of 400 ml/min. The temperature was kept at 710° C. for eight hours, and then lowered to room temperature by natural cooling. Thus, a titanium suboxide support 5 was obtained.

### (2) Production of Powder of Comparative Example 3

A powder of Comparative Example 3 was produced as in Example 3, except that the titanium suboxide support 5 was used instead of the titanium suboxide support 2 used in the production of the powder of Example 3.

### Comparative Example 4

A powder of Comparative Example 4 was produced as in Example 4, except that the titanium suboxide support 5 was used instead of the titanium suboxide support 2 used in the production of the powder of Example 4.

### Comparative Example 5

A powder of Comparative Example 5 was produced as in Example 2, except that 0.13 g of an aqueous chloroplatinic acid solution (15.343% in terms of Pt, TANAKA Kikinzoku Kogyo K.K.) was used instead of the ruthenium chloride solution in the production of the powder of Example 2.

The catalysts obtained in Examples 1 to 10 and Comparative Examples 1 to 5 were analyzed to evaluate, using the methods described below, the composition of titanium oxide, the specific surface area of the support, a brightness value L* and chromaticity values a* and b* of the support, a loading amount of Ru or Pt, ammonia synthesis activity, and a weight loss of a catalyst used in the ammonia synthesis reaction. Comparative Example 6 was prepared in which ruthenium-loaded carbon was analyzed to evaluate a weight loss of the catalyst. The results are shown in Table 1.

### <Loading Amount of Ru or Pt>

The amount of Ru or Pt in each sample was measured using a scanning X-ray fluorescence spectrometer ZSX Primus II (Rigaku Corporation) to determine the loading amount of Ru or Pt.

### <Specific Surface Area (BET-SSA)>

In accordance with JIS Z 8830 (2013), each sample was heated at 200° C. for 60 minutes in a nitrogen atmosphere, and then the specific surface area (BET-SSA) was measured using a specific surface area meter (trade name: “Macsorb HM-1220” available from Mountech Co., Ltd.).

### <Determination of Value x in Composition Formula TiOx of Titanium Oxide>

The value x in the compositional formula TiOx of titanium oxide was determined by measuring the weight change of a titanium oxide powder before and after heating by the following procedure.

Specifically, a given amount of a titanium oxide powder to be measured was preliminarily dried at 100° C. for one hour using a dryer (an air convection constant temperature oven DKM600 available from Yamato Scientific Co., Ltd.) so that the moisture adsorbed thereto was removed; and about 1-g portion of the titanium oxide powder was weighed in a magnetic crucible using an electronic balance (an analysis balance ATX224 available from Shimadzu Corporation) and heated at 900° C. for one hour under atmospheric conditions using an electric furnace (a desktop electric furnace NHK-120H-II available from Nitto Kagaku Co., Ltd.). Thus, the titanium oxide powder was converted to completely oxidized TiO₂ (x=2.00). After heating, the crucible was transferred into a glass desiccator and allowed to cool to room temperature and then, weighed again. When the weight increment before and after heating corresponds to the amount of oxygen lacking in the titanium oxide powder before heating as compared with TiO₂, the following relationships are satisfied:

Number of moles of TiOx₁ before heating=W₁/(M_{T}+x₁Mₒ)

Number of moles of TiO₂ after heating=W₂/(M_{T}+2M₀)

where TiOx₁ is the composition formula of titanium oxide before heating, W₁ (g) is the weight before heating, W₂ (g) is the weight after heating, M_{T} is the atomic weight of Ti, and Mₒ is the atomic weight of O.

Since the number of moles of TiOx₁ before heating is equal to the number of moles of TiO₂ after heating, the following relationship is satisfied.

W₁/(M_{T}+x₁Mₒ)=W₂/(M_{T}+2Mₒ)

The above equation solved for x₁ yields the following equation.

x₁=(W₁(M_{T}+2M₀)=W₂/(M_{T}+2Mₒ)

Thus, x₁ is determined using the above equation.

Furthermore, the influence of weight change caused by heating moisture adhered to the titanium oxide to be measured before heating is excluded as follows: titanium oxide (trade name: “STR-100N” available from Sakai Chemical Industry Co., Ltd., specific surface area: 100 m²/g) was preheated by the above-described method to prepare a powder as a standard powder; the standard powder was then heated again; x₁ in the composition formula TiOx₁ of the titanium oxide standard powder was determined from the weight increment before and after the heating and defined as x_{STD}; a value x₁ of any of the powders of the examples and comparative examples determined by the above method are multiplied by 2/x_{STD} to determine the value x in the composition formula TiOx of the titanium oxide. When the value x obtained by multiplying the value x₁ by 2/x_{STD} is greater than 2, excessive moisture adhered to the titanium oxide is considered to influence the weight change. In this case, the value x is determined to be 2.

### <Brightness Value L* and Chromaticity Values a* and b* in L*a*b* Color System>

A brightness value L* and chromaticity values a* and b* in the L*a*b* color system were determined using a colorimeter (trade name “SE2000” available from Nippon Denshoku Industries Co., Ltd.).

### <Ammonia Synthesis Activity Evaluation>

Samples for ammonia synthesis activity evaluation were prepared from the powders of the examples and comparative examples as follows: a 0.4-g portion of any of the powders was placed in a mold (φ=20 mm) and pressed at a pressure of 160 MPa using a pressing machine to obtain pellets; the pellets were pulverized so as to pass through a 250-μm mesh sieve; the molded powder passed through the 250-μm mesh sieve was passed through a 150-μm mesh sieve; and the molded powder left on the 150-μm mesh sieve was collected. The sample for ammonia synthesis activity evaluation was set in an ammonia synthesis activity evaluation apparatus. The temperature thereof was increased to 600° C. over 30 minutes at atmospheric pressure under a hydrogen flow of 60 ml/min and a nitrogen flow of 20 ml/min as a pretreatment. The temperature was kept at 600° C. for 30 minutes and lowered to 550° C. over seven minutes. The temperature was kept for 53 minutes, during which the average ammonia production was measured using FTIR (apparatus name: IS50, available from Thermo Fisher Scientific K.K.). The temperature was further lowered to 450° C. over 14 minutes. The temperature was kept for 53 minutes, during which the ammonia production was measured in the same manner as described above. The temperature was further lowered to 400° C. over seven minutes. The temperature was kept for 53 minutes, during which the ammonia production was measured in the same manner as described above.

### <Evaluation of Weight Loss of Catalyst in Ammonia Synthesis Atmosphere>

As for the powders of the examples and comparative examples and a ruthenium-loaded carbon powder (trade name: “Ruthenium on activated carbon (Ru 5%)” available from FUJIFILM Wako Pure Chemical Corporation), the following procedure was performed. A 0.1-g portion of any of these powders was put in an alumina boat. The workpiece was put in an atmospheric furnace, and the temperature thereof was increased to 600° C. over 180 minutes under a hydrogen flow of 150 ml/min and a nitrogen flow of 50 ml/min. The temperature was kept at 600° C. for 240 minutes, and then lowered to room temperature by natural cooling. The weight of the powder taken out from the furnace was measured. The resulting weight was subtracted from the weight of the powder before sintering in the atmospheric furnace, and the resulting difference was divided by the weight of the powder before sintering in the atmospheric furnace. Thereby, the percentage of the weight loss of the catalyst was determined.

TABLE 1

| | | BET | | | | | | | | | | |
|---|---|---|---|---|---|---|---|---|---|---|---|---|
| | | specific | | | | | | | | | | Percentage |
| | | surface | | | | Metal | | | NH₃ | NH₃ | NH₃ | of weight |
| | TiOx | area of | | | | loaded | Loading | | production | production | production | loss of |
| | support | support | Support | Support | Support | on | amount | Raw | [ppm] at | [ppm] at | [ppm] at | catalyst |
| | Value x | [m²/g] | L* | a* | b* | support | [%] | material | 400° C. | 450° C. | 550° C. | (%) |
| Example 1 | 1.76 | 11 | 34.9 | −1.8 | −4.9 | Ru | 5 | Ru(NO₃)₃ | 83 | 215 | 513 | 0 |
| Example 2 | 1.76 | 11 | 34.9 | −1.8 | −4.9 | Ru | 5 | RuCl₃ | 20 | 73 | 379 | 0 |
| Example 3 | 1.98 | 15 | 80.4 | −1.7 | −4.5 | Ru | 1 | Ru(NO₃)₃ | 13 | 52 | 334 | 0 |
| Example 4 | 1.98 | 15 | 80.4 | −1.7 | −4.5 | Ru | 1 | RuCl₃ | 19 | 52 | 326 | 0 |
| Example 5 | 1.75 | 37 | 31.6 | 0.4 | −3.3 | Ru | 1 | Ru(NO₃)₃ | 40 | 163 | 545 | 0 |
| Example 6 | 1.75 | 37 | 31.6 | 0.4 | −3.3 | Ru | 10 | Ru(NO₃)₃ | 84 | 235 | 642 | 0 |
| Example 7 | 1.75 | 37 | 31.6 | 0.4 | −3.3 | Ru | 1 | RuCl₃ | 8 | 48 | 332 | 0 |
| Example 8 | 1.98 | 35 | 55.5 | −0.4 | −12.0 | Ru | 1 | Ru(NO₃)₃ | 96 | 235 | 564 | 0 |
| Example 9 | 1.98 | 35 | 55.5 | −0.4 | −12.0 | Ru | 1 | RuCl₃ | 69 | 199 | 539 | 0 |
| Example 10 | 1.98 | 35 | 55.5 | −0.4 | −12.0 | Ru | 5 | Ru(NO₃)₃ | 164 | 377 | 640 | 0 |
| Comparative | 2 | 100 | 97.6 | −0.5 | 1.7 | Ru | 1 | Ru(NO₃)₃ | 0 | 29 | 161 | — |
| Example 1 | | | | | | | | | | | | |
| Comparative | 2 | 100 | 97.6 | −0.5 | 1.7 | Ru | 1 | RuCl₃ | 2 | 42 | 198 | — |
| Example 2 | | | | | | | | | | | | |
| Comparative | 1.49 | 9 | 31.7 | −0.3 | −1.8 | Ru | 1 | Ru(NO₃)₃ | 0 | 2 | 24 | — |
| Example 3 | | | | | | | | | | | | |
| Comparative | 1.49 | 9 | 31.7 | −0.3 | −1.8 | Ru | 1 | RuCl₃ | 0 | 6 | 17 | — |
| Example 4 | | | | | | | | | | | | |
| Comparative | 1.76 | 11 | 31.6 | 0.4 | −3.3 | Pt | 2 | H₂PtCl₆ | 6 | 5 | 4 | — |
| Example 5 | | | | | | | | | | | | |

| | | |
|---|---|---|
| Comparative | Ru-loaded carbon | 56 |
| Example 6 | | |

The catalysts obtained in Examples 10 to 26 were analyzed to evaluate the composition of titanium oxide, the specific surface area of the support, a brightness value L* and chromaticity values a* and b* of the support, a loading amount of each metal element, and ammonia synthesis activity.

The composition of titanium oxide, the specific surface area of the support, the brightness value L* and chromaticity values a* and b* of the support were measured by the same methods as in Examples 1 to 10 and Comparative Examples 1 to 5. The loading amount of each metal element was measured by the same method as that used to measure the loading amount of Ru or Pt.

The ammonia synthesis activity was evaluated in the following way.

### <Ammonia Synthesis Activity Evaluation>

Samples for ammonia synthesis activity evaluation were prepared from the powders of Examples 10 to 26 as follows: a 1.0-g portion of any of the powders was placed in a mold (φ=20 mm) and pressed at a pressure of 30 MPa using a pressing machine to obtain pellets; the pellets were pulverized so as to pass through a 1.4-mm mesh sieve; the molded powder passed through the 1.4-mm mesh sieve was passed through a 600-μm mesh sieve; and the molded powder left on the 600-μm mesh sieve was collected. The sample for ammonia synthesis activity evaluation was fixed in the center of a quartz tube with a diameter of 1 cm and a length of 38 cm. The quartz tube was set in an infrared furnace. A flow of nitrogen of 200 ml/min was introduced into the quartz tube at atmospheric pressure for five minutes. The temperature was then increased to 500° C. over 2.5 hours under a gas mixture flow of a hydrogen flow of 180 ml/min and a nitrogen flow of 60 ml/min. A gas generated during increasing the temperature was blown into a 0.04 M aqueous sulfuric acid solution under stirring, and the change in electrical conductivity of the aqueous sulfuric acid solution per second was measured using an electrical conductivity meter (trade name: portable conductivity meter CM-31P available from DKK-TOA Corporation). Then, the average of the change in electrical conductivity in six minutes was determined, and the ammonia production was calculated from the previously measured calibration curve.

TABLE 2

| | TiOx | BET specific | | | | Metal (1) | Metal (2) | Metal (3) |
|---|---|---|---|---|---|---|---|---|
| | support | surface area of | Support | Support | Support | loaded | loaded | loaded |
| | Value x | support [m²/g] | L* | a* | b* | on support | on support | on support |
| Example 10 | 1.98 | 35 | 55.5 | −0.4 | −12.0 | Ru | — | — |
| Example 11 | 1.98 | 35 | 55.5 | −0.4 | −12.0 | Ru | Ca | Cs |
| Example 12 | 1.98 | 35 | 55.5 | −0.4 | −12.0 | Ru | Ca | Cs |
| Example 13 | 1.98 | 35 | 55.5 | −0.4 | −12.0 | Ru | Ca | Cs |
| Example 14 | 1.98 | 35 | 55.5 | −0.4 | −12.0 | Ru | Ca | — |
| Example 15 | 1.98 | 35 | 55.5 | −0.4 | −12.0 | Ru | Ca | — |
| Example 16 | 1.98 | 35 | 55.5 | −0.4 | −12.0 | Ru | Ca | — |
| Example 17 | 1.98 | 35 | 55.5 | −0.4 | −12.0 | Ru | Ca | — |
| Example 18 | 1.98 | 35 | 55.5 | −0.4 | −12.0 | Ru | Cs | — |
| Example 19 | 1.98 | 35 | 55.5 | −0.4 | −12.0 | Ru | Mg | — |
| Example 20 | 1.98 | 35 | 55.5 | −0.4 | −12.0 | Ru | La | — |
| Example 21 | 1.98 | 35 | 55.5 | −0.4 | −12.0 | Ru | Ba | — |
| Example 22 | 1.98 | 35 | 55.5 | −0.4 | −12.0 | Ru | Ca | La |
| Example 23 | 1.98 | 35 | 55.5 | −0.4 | −12.0 | Ru | Ca | Ba |
| Example 24 | 1.98 | 35 | 55.5 | −0.4 | −12.0 | Ru | Sr | La |
| Example 25 | 1.98 | 35 | 55.5 | −0.4 | −12.0 | Ru | Ca | Ce |
| Example 26 | 1.98 | 35 | 55.5 | −0.4 | −12.0 | Ru | Ba | Cs |

| | Loading | Loading | Loading | | | |
|---|---|---|---|---|---|---|
| | amount | amount | amount | NH₃ production | NH₃ production | NH₃ production |
| | (1) [%] | (2) [%] | (3) [%] | [ppm] at 400° C. | [ppm] at 450° C. | [ppm] at 500° C. |
| Example 10 | 5 | — | — | 37 | 87 | 111 |
| Example 11 | 4 | 8 | 8 | 866 | 1981 | 1362 |
| Example 12 | 5 | 8 | 1 | 371 | 1238 | 1238 |
| Example 13 | 4 | 7 | 14 | 991 | 1486 | 1238 |
| Example 14 | 5 | 1 | — | 124 | 495 | 619 |
| Example 15 | 5 | 3 | — | 495 | 991 | 991 |
| Example 16 | 5 | 8 | — | 180 | 765 | 1062 |
| Example 17 | 4 | 18 | — | 124 | 495 | 830 |
| Example 18 | 5 | 9 | — | 93 | 454 | 958 |
| Example 19 | 4 | 8 | — | 106 | 329 | 780 |
| Example 20 | 5 | 8 | — | 123 | 248 | 495 |
| Example 21 | 5 | 8 | — | 45 | 197 | 624 |
| Example 22 | 4 | 8 | 8 | 248 | 1114 | 1114 |
| Example 23 | 4 | 8 | 7 | 124 | 743 | 867 |
| Example 24 | 4 | 8 | 8 | 495 | 619 | 867 |
| Example 25 | 4 | 7 | 8 | 248 | 371 | 619 |
| Example 26 | 4 | 8 | 8 | 124 | 124 | 619 |

Comparison of ammonia production between the powders of Examples 1 to 10 and the powders of Comparative Examples 1 and 2 at 400° C., 450° C., and 550° C. revealed that the powders of the examples generated a larger amount of ammonia and that the titanium suboxide represented by the composition formula TiOx where x satisfies x<2 had higher ammonia synthesis activity.

Comparison of ammonia production between the powders of Examples 1 to 10 and the powders of Comparative Examples 3 and 4 revealed that the powders of the examples generated a larger amount of ammonia and that the titanium suboxide powders represented by the composition formula TiOx where x was larger than 1.5 had higher ammonia synthesis activity.

Comparison of ammonia production between the powders of Examples 1 and 2 and the powder of Comparative Example 5 revealed that the powders of Examples 1 and 2 generated a larger amount of ammonia and that the loading of ruthenium as a metal was effective. Furthermore, the weight loss of 56 parts by weight of the catalyst was observed in the ruthenium-loaded carbon powder in the ammonia synthesis atmosphere, whereas no loss of the catalyst was observed in the powders of Examples 1 to 10.

Comparison of the value L* and the value b* between the titanium oxide supports used in the powders of Examples 1 to 10 and the titanium oxide supports used in the powders of Comparative Examples 1 to 4 revealed that the titanium oxide having a value L* of 30 or higher and a value b* of not higher than −2, when loaded with ruthenium, had higher ammonia synthesis activity than dark titanium oxide having a value L* of lower than 30 and yellowish titanium oxide having a value b* of higher than −2.

Comparison of ammonia production among the powders of Examples 10 to 26 revealed that the powders of Examples 11 to 26, which were loaded with not only ruthenium but also metal element having a lower electronegativity than titanium, generated a larger amount of ammonia than the powder of Example 10, which was loaded with only ruthenium, at all of the temperatures. This revealed that the catalysts loaded with metal element having a lower electronegativity than titanium in addition to ruthenium had higher ammonia synthesis activity.

The results of Examples 11 to 26 revealed that in the catalysts of the present invention, the metal element having a lower electronegativity than titanium was preferably calcium, and use of a combination of calcium and cesium or lanthanum provided a catalyst having higher ammonia synthesis activity.

These revealed that the catalysts of the present invention were free from catalyst deactivation caused by reaction of the supports and can exhibit good catalytic activity in low-temperature, low-pressure processes.

1. An ammonia synthesis catalyst having a structure in which at least one of ruthenium or an oxide of ruthenium is loaded on a titanium suboxide support represented by the composition formula TiOx where x represents a number satisfying 1.5<x<2.0.

2. The ammonia synthesis catalyst according to claim 1,
wherein a loading amount of the at least one of ruthenium or an oxide of ruthenium is 0.1 to 30 parts by weight in terms of ruthenium metal element based on total 100 parts by weight of the ammonia synthesis catalyst.

3. The ammonia synthesis catalyst according to claim 1,
wherein the ammonia synthesis catalyst has a structure in which at least one of a simple substance of a metal element having a lower Pauling electronegativity than titanium or a compound of the metal element is loaded on the support.

4. The ammonia synthesis catalyst according to claim 3,
wherein a loading amount of the at least one of a simple substance of a metal element having a lower Pauling electronegativity than titanium or a compound of the metal element is 0.1 to 50 parts by weight in terms of metal element based on total 100 parts by weight of the ammonia synthesis catalyst.

5. A method for producing ammonia, comprising:
using the ammonia synthesis catalyst according to claim 1.
